(19) United States
(12) Patent Application Publication
(10) Pub. No.: US 2024/0152333 A1
(43) Pub. Date: May 9, 2024

(54) SYSTEMS AND METHODS FOR MODELLING, PREDICTING AND SUGGESTING FUNCTION COMPLETION TIMELINES

(71) Applicant: Capital One Services, LLC, McLean, VA (US)

(72) Inventors: Madhavan CHANDRAN, Mckinney, TX (US); Elijah CARTER, Alexandria, VA (US); Cary BLOOM, Gaithersburg, MD (US); Tahmina KHAN, Fairfax, VA (US); Cory WILLIAMS, Vienna, VA (US)

(73) Assignee: Capital One Services, LLC, McLean, VA (US)

(21) Appl. No.: 18/053,600

(22) Filed: Nov. 8, 2022

(51) Int. Cl. G06F 8/20; G06N 20/00

(52) U.S. Cl. CPC G06F 8/20; G06N 20/00

(57) ABSTRACT

Methods and systems are described herein for generating function completion timelines using machine learning models. The system may receive a validation request for validating completion of a function, determine a class of the logic input data, add the class to the validation request, input the validation request into a machine learning model for generating a prediction of a completion timeline, and generate the prediction of a completion date based on the completion timeline.

### BACKGROUND

As the complexity of functions within software applications increases, it has become increasingly difficult to assess the trajectory of a given software development timeline in real time. The number of factors, both human and computational, that influence the level and ease of compliance of a software application with its stated goals and requirements is large. Furthermore, the development of an application (including compliance requirement satisfaction) depends upon feedback from relevant decision-makers, which may be expressed verbally. Various development processes may be linked to others or may have dependencies that complicate any predictions of when a given project or its compliance processes may be completed, as well as what steps are needed for this completion. Conventionally, relevant decision-makers make predictions based on subjectively assessing qualitative feedback from developers or other stakeholders, while weighing subjective information and experience. Thus, it is difficult to deterministically predict the development timeline of a project, while also taking all past function completion data and qualitative feedback from those involved in the process into account where compliance has not been achieved yet.

### SUMMARY

Methods and systems are described herein for generating function completion timelines for a software development process using machine learning models. The system may use machine learning techniques to determine, based on user input from stakeholders and process owners, development timelines, languages for communications, compliance techniques and decision making. As a result, the system may enable process owners to make predictions or suggestions for large-scale software development initiatives over time, in a deterministic, objective manner. By doing so, the system may leverage past information to predict the optimal actions and outcomes of a process, enabling decision-makers to improve efficiency and speed in achieving compliance for large-scale software initiatives.

More specifically, the system may utilize techniques such as natural language processing, category bucketing and machine learning (e.g., regression) to learn from both quantitative and qualitative data from both previous processes and the current process. By relying on a multitude of data types and sources, the system may generate suggestions as to timelines for completion, language for future communications, the best tasks to carry out for compliance with objectives, and decision making in general. By processing these different types of data arising from the development process, the system may make deterministic software development suggestions, which may yield predicted timelines, decisions and suggested language for communications, in order to improve the efficiency and reliability of predictions.

The system may receive a request for determining information about function timelines and compliance achievement. That is, the system may receive a validation request for validating completion of a first function. The validation request may include logic input data, timing data and performance data. The system may, for example, include logic input data relating to communications from developers or stakeholders detailing reasons for struggling to achieve compliance. Relevant stakeholders may ask questions relating to why compliance has not been reached yet, how difficult the process may be and why, the reason for any missed deadlines, or what was done to complete a given task. For example, a security application may require certain encryption before it is able to achieve compliance. During the development process, this encryption may not have been implemented, in which case a system may flag the process as being non-compliant.

In response to a stakeholder's questions, a developer may describe why the process has not yet reached compliance, such as because an encryption algorithm implemented in the security application was not able to handle a particular data type. These communications from the developers may be in the form of emails, text messages or voicemails, and may be answered by any corresponding developers or contributors. The system may also receive timing data, such as data relating to when the project started, or how far behind the function is from deadlines. Performance data may include whether the given function has achieved compliance or not, for example. By receiving this information in the form of a validation request, the system may gather any relevant information that may determine reasons for lack of compliance, as well as requirements for achieving compliance. Thus, the system may subsequently process this information to generate the desired predictions or suggestions.

The system may also receive supplemental logic input data, supplemental timing data, and supplemental performance data, and may determine that the function is complete, in which case it may execute a training routine with this supplemental data. That is, the system may receive, for the first function, supplemental logic input data, supplemental timing data, and supplemental performance data. The supplemental timing data may include a start date and an end date for the first function, and the supplemental performance data may include a completion status indicator for the first function. In response to determining, based on the supplemental performance data, that the first function is complete, the system may execute a training routine of the machine learning model with the logic input data, the timing data, the performance data, the supplemental logic input data, the supplemental timing data and the supplemental performance data. The training routine may update the machine learning model. In other words, the system may receive supplemental data regarding the function, including new logic input data, timing data and performance data. This supplemental performance data may be used to update the system that the function has attained compliance and, in response, may add this information to the training data. By doing so, the system may dynamically train the machine learning model as functions or development processes are completed, adding to the wealth of information considered in the model.

In some embodiments, the system may receive additional input function data, where multiple functions and their corresponding data may be queried through the machine learning model. The system may then generate a second validation request for all of these functions, input this request into the machine learning model, and generate predicted completion dates for each of the functions that were queried. In other words, the system may receive input function data. The input function data may include a list of functions to be completed sequentially. The input function data may also include logic input data, a corresponding logic input class data, timing data and performance data corresponding to each function to be completed sequentially. The system may generate a second validation request including the input function data, input the second validation request into the machine learning model, and generate, using the machine learning model, a plurality of predicted completion dates for each function in the list of functions to be completed sequentially.

In one example, the system may receive information regarding four tasks that must all reach compliance before a project is completed. These tasks may each include communications relating to why these tasks have not been compliant (i.e., corresponding logic input data), a class relating to this compliance (i.e., corresponding logic input class data), as well as deadlines or timelines for each task (i.e., corresponding timing data) and data regarding whether compliance has been achieved (i.e., corresponding performance data). The system may then generate predicted completion timelines of achieving compliance for each of these functions sequentially by inputting this information through the machine learning model. By doing so, the system may handle complicated development processes that may involve multiple functions or tasks that require compliance at the same time.

The system may determine a class of the logic input data. That is, the system may determine, based on the logic input data, a class of the logic input data. For example, the system may receive, in the form of text-based sentences, email communications from developers or stakeholders regarding why a particular development goal has not been achieved yet. Based on these communications, the system may determine a category for the initiative or project based on the reason for missing compliance, for example, using a natural language processor. By doing so, the system may analyze and subsequently label the particular development process by classifying the process by the reason for missing the stated goals. This classification, in the form of a class derived from the logic input data, may provide information that may be subsequently used to predict how long it may take to reach compliance, as well as how this may be accomplished.

In some embodiments, to determine a class of the logic input data, the system may generate a vector representation of the logic input data, input this vector representation into a natural language processing model, and receive the class of the logic input data from the natural language processing model. The natural language processing machine learning model may have been trained using vectors of training logic input datasets, and may receive from the natural language processing machine learning model the class of the logic input data. For example, the system may receive logic input data in the form of an email message, with a subject line, a date, a body of the message, and a sign-off. The system may, subsequently, vectorize the message into a series of vectors of lines. Each line may be a vector of words, and each word may be an array of characters. Subsequently, the system may input the vectors of words into a natural language processing machine learning model, such as one that has named entity recognition and text summarization systems. The system may then summarize and classify the contents of the email message into a “class,” which may summarize any reasons for which an application has not reached compliance. For example, a security application that has not properly implemented encryption of its communications may receive a class such as “encryption deficiency.” By utilizing a natural language processing algorithm, the system may automatically detect any issues that are affecting compliance, which enables the system to efficiently address the root cause of any issues during the development process.

The system may add the class to the validation request. Here, the system may append the class information derived from the logic input data to the validation request, in order to enable the system to take into account information regarding the reasons for not achieving compliance. In this manner, the system may take advantage of verbal, qualitative information in the form of email communications. In classifying large-scale initiatives using this information, the system may leverage category bucketing to sharpen any analysis of the function and make this information easier to process.

The system may input the validation request into a machine learning model to generate a prediction of the function's completion timeline. That is, the system may input the validation request into a machine learning model for generating a prediction of a completion timeline for the first function. The machine learning model may have been trained using a training dataset that includes multiple features and entries that include training logic input data, training timing data and training performance data. Thus, after classifying any logic input data into classes relating to reasons for a lack of compliance, the system may then input this logic input data, as well as timeline data and performance data, into a machine learning model that has already been trained with past processes. These past processes may also include communications between relevant decision-makers, stakeholders and developers, and may include data on timelines for achieving compliance in the past, as well as performance data. This training dataset may also involve classification of corresponding training logic input data. In inputting the validation request into the machine learning model, the system may, for example, use regression to compare the current process with past processes to generate suggestions and predictions based on similar past processes. The system may then generate a completion timeline, which may, for example, include a prediction of a time until compliance is expected to be reached.

In order to train the machine learning model, the system may receive a training dataset. In particular, the system may receive the training dataset for training the machine learning model to generate predictions of completion timelines. The training dataset may include the plurality of features and the plurality of entries. The plurality of features may include the training logic input data, the training timing data and the training performance data. For example, the system may receive information relating to past development processes for other functions, such as other security applications from the past. This information may include information regarding any reasons for delays in reaching compliance for these other applications, as well as timeline data and performance data regarding when and whether compliance was ever reached.

For each training data entry, the system may determine a class for the training logic input data. That is, the system may determine, for each entry within the training dataset, a corresponding class of a plurality of classes for the training logic input data. The plurality of classes may include an indication of completion failure. For example, the system may determine for another security application that the corresponding class is “encryption deficiency” by analyzing communications during the prosecution process. However, another entry in the training dataset may be classified as “glitchy user interface,” where the application has been determined to suffer from user interface issues. Thus, the system may similarly extract classes from previous applications' development processes and add this class to the entries. That is, the system may add the corresponding class to each of the plurality of entries. The system, having determined a class for which compliance may not have been achieved based on training data, may subsequently train the machine learning model using this data. That is, the system may train the machine learning model to generate the predictions of completion timelines using the training dataset. Here, the system may train the machine learning model that generates timeline predictions based on past data relating to other applications. For example, the system may use backpropagation in the case of an artificial neural network, where weights within hidden layers are iteratively modified in order to improve the prediction with respect to the training data and the actual timelines corresponding to these training data entries. By doing so, the system may be able to leverage past information about compliance and how various factors relating to development, such as reasons for non-compliance and other logic-related data, for example, through communications, affect the timelines for achieving compliance.

In some embodiments, the system may receive communication data within the training dataset and train the machine learning model to output a suggested communication. That is, the system may receive communication data within the training dataset, such that the communication data includes a plurality of communications and dates of communication and may train the machine learning model based on the communication data to output a communication for indicating to a user to complete a corresponding function. For example, the system may receive email messages from previous development processes. By receiving communication data that is linked to the training dataset, the machine learning model may, for example, learn which communications lead to more efficient compliance, and which are detrimental to compliance objectives. Subsequently, the machine learning model may generate suggested communications in order to achieve compliance. For example, the system may suggest that a user try another encryption algorithm, so that a security application may achieve compliance.

The system may generate the prediction of a completion date. That is, the system may generate the prediction of a completion date based on the completion timeline. Here, the system may, based on the results of the machine learning model, predict an ultimate date for when the system has calculated a most likely date of completion for the project. This estimate may be based on both qualitative information contained in communications between stakeholders, as well as quantitative information in the form of timelines and compliance or performance information. Thus, the system is able to generate a prediction for when an initiative may achieve compliance, based on a plethora of prior information.

In some embodiments, the machine learning model may calculate a list of estimated completion dates and corresponding probabilities, which may then be used to determine a prediction of the completion date. That is, the system may receive, from the machine learning model, a list of estimated completion dates and corresponding completion probabilities and determine, based on the list of estimated completion dates and the corresponding completion probabilities, an estimated completion date as the prediction of the completion date. For example, the machine learning model may generate probabilities of completing a function prior to a list of dates. The model may determine that the function may only have a 0.5% chance of reaching compliance by 03/01/2024, but a 79.01% chance of reaching compliance by 07/01/2024. The system may, based on these predictions, determine a predicted completion date of Jul. 1, 2024. In calculating a variety of possible completion dates and comparing probabilities, the machine learning model provides the system with information about confidence in its prediction, which may be useful information for stakeholders as well.

In some embodiments, the system may receive a request for a probability of completion before a query completion time and determine a subset of the training data that matches the class of the logic input data for the function. The system may then determine a plurality of elapsed completion times and, by calculating a percentage of elapsed completion times less than the query completion time, the system may determine the probability of completion before the query completion time. That is, the system may receive a request for a probability of completion before a query completion time, and may determine, based on the class of the logic input data and the training dataset, a subset of training data matching the class of the logic input data, such that the subset of training data may include start dates and completion dates. The system may determine, based on the start dates and the completion dates, a plurality of elapsed completion times, calculate a percentage of elapsed completion times less than the query completion time, and determine the probability of completion before the query completion time. For example, the system may receive a request to determine a probability that the development process will be completed (i.e., compliance will be achieved) by 07/10/2024. The system may then isolate only those development processes in the training data that correspond to the same logic input class (e.g., prior applications that suffered from an “encryption deficiency”), and determine a percentage of those that were completed before the date. This percentage provides an indication of the likelihood that compliance will be achieved before the query completion date provided.

Various other aspects, features and advantages of the system will be apparent through the detailed description and the drawings attached hereto. It is also to be understood that both the foregoing general description and the following detailed description are examples, and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data), unless the context clearly dictates otherwise.

### BRIEF DESCRIPTION OF THE DRAWINGS

FIG. 1 shows an illustrative environment for analyzing functions to predict completion timelines, in accordance with one or more embodiments.

FIG. 2 shows an excerpt of a data structure for a validation request and input function data, in accordance with one or more embodiments.

FIG. 3 shows a process for generating a vector representation of logic input data and generating a logic input data class from a natural language processor, in accordance with one or more embodiments.

FIG. 4 shows an excerpt of a data structure for predictions from a machine learning model for generating predictions of completion timelines for functions, in accordance with one or more embodiments.

FIG. 5 shows illustrative components for a system interfacing with a machine learning model, in accordance with one or more embodiments.

FIG. 6 illustrates a computing device, in accordance with one or more embodiments of this disclosure.

FIG. 7 shows a flowchart of operations for generating function completion timelines using machine learning models, in accordance with one or more embodiments.

### DETAILED DESCRIPTION OF THE DRAWINGS

In the following description, for the purposes of explanation, numerous specific details are set forth in order to provide a thorough understanding of the embodiments of this invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

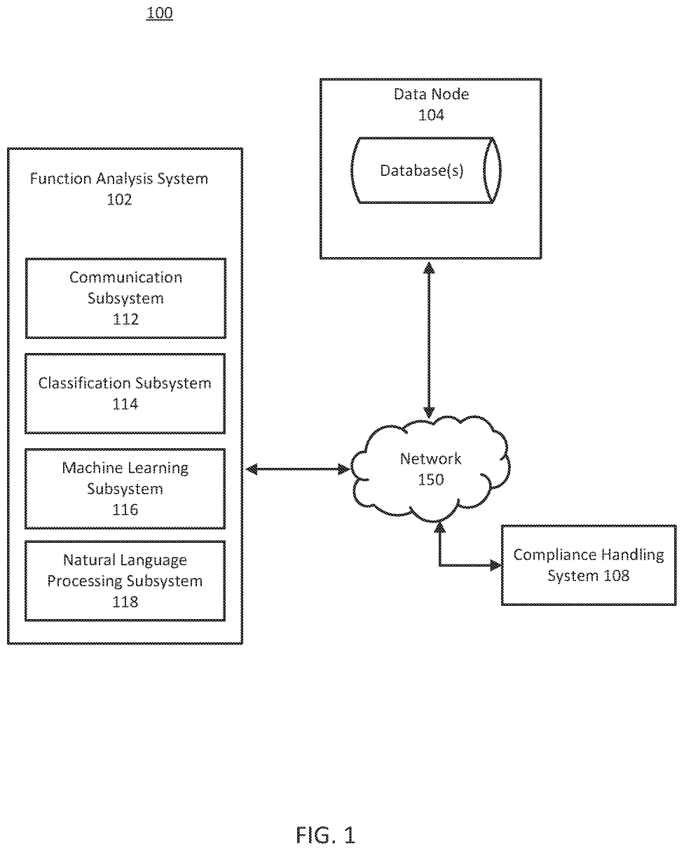

FIG. 1 shows an illustrative environment for analyzing functions to predict completion timelines, in accordance with one or more embodiments. Environment 100 includes function analysis system 102, data node 104 and compliance handling system 108. Function analysis system 102 may include software, hardware, or a combination of both and may reside on a physical server or a virtual server running on a physical computer system. In some embodiments, function analysis system 102 may be configured on a user device (e.g., a laptop computer, a smart phone, a desktop computer, an electronic tablet, or another suitable user device).

Data node 104 may store various data, including one or more machine learning models, training data, and/or input data. Types of data that may be stored on data node 104 may include logic input data, timeline data, performance data, input function data, predicted timeline data, suggested communications data, function completion date probability data, or predicted completion dates. Additionally, data stored in data node 104 may be stored in vectorized form or plain-text form, and may include a variety of variable types, such as alphanumeric characters, strings, or bits. Data node 104 may include software, hardware, or a combination of the two, and may include databases or stand-alone data. In some embodiments, function analysis system 102 and data node 104 may reside on the same hardware and/or the same virtual server or computing device. Network 150 may be a local area network, a wide area network (e.g., the Internet), or a combination of the two. Compliance handling system 108 may reside on client devices (e.g., desktop computers, laptops, electronic tablets, smartphones, servers, and/or other computing devices that interact with network 150, data node 104 and function analysis system 102). Compliance handling system 108 may also reside on the same hardware and/or the same virtual server or computing device as data node 104 and function analysis system 102, or may be accessible to data node 104 and function analysis system 102 through network 150 or another manner. Compliance handling system 108 may also exist within function analysis system 102 in the form of a subsystem.

Compliance handling system 108 may handle issues related to compliance for functions. For example, compliance handling system 108 may detect issues with software development processes, where compliance has not been reached. Compliance handling system 108 may have access to communication data between stakeholders, developers and managers, for example, and may have access to timing data, such as task start dates, completion dates or deadlines. Compliance handling system 108 may also collect information related to the performance of functions or processes, and may document specific features that have not reached compliance, for example. Function analysis system 102 may, through communication subsystem 112, receive validation requests, training datasets, communication data, supplemental data, or other data or requests, for example, those originating from compliance handling system 108. Communication subsystem 112 may include software components, hardware components or a combination of both. For example, communication subsystem 112 may include a network card (e.g., a wireless network card and/or a wired network card) that is associated with software to drive the card and enables communication with network 150. In some embodiments, communication subsystem may also receive data from and/or communicate with data node 104 or another computing device. Communication subsystem 112 may communicate with classification subsystem 114, machine learning subsystem 116 or natural language processing subsystem 118.

In some embodiments, function analysis system 102 may include classification subsystem 114. Classification subsystem 114 may perform tasks that aid in the classification of data, for example training data or logic input data. For example, classification subsystem 114 may generate a class of logic input data from a validation request's logic input data by utilizing natural language processing subsystem 118 and machine learning subsystem 116. Classification subsystem 114 may include software components, hardware components or a combination of both. For example, classification subsystem 114 may include software components, or may include one or more hardware components (e.g., processors) that are able to execute operations for analyzing input data or training data and generating corresponding classes. Classification subsystem 114 may access data, such as logic input data, timing data, and performance data, as well as training logic input data, training timing data, and training performance data. Classification subsystem 114 may also access validation requests, logic input class data from both training datasets and input data, and communication data. Classification subsystem 114 may receive datasets through communication subsystem 112, which may also include supplemental logic input data, supplemental timing data and supplemental performance data. These forms of data may be stored in, for example, a memory system. Classification subsystem 114 may directly access data nodes or information stored in compliance handling system 108. Classification subsystem 114 may, additionally or alternatively, receive data from and/or send data to communication subsystem 112, machine learning subsystem 116 or natural language processing subsystem 118.

Machine learning subsystem 116 may execute tasks relating to machine learning, for example, generating predictions of completion timelines for functions, generating suggested communications, generating pluralities of predicted completion timelines for functions to be completed sequentially, calculating probabilities of completion before a given query completion time, or generating lists of estimated completion dates and corresponding completion probabilities. Machine learning subsystem 116 may include software components, hardware components, or a combination of both. Machine learning subsystem 116 may receive and/or send data to communication subsystem 112, classification subsystem 114 or natural language processing subsystem 118. For example, machine learning subsystem 116 may receive training datasets through communication subsystem 112 from a database on data node 104. Other data that machine learning subsystem 116 may receive may include logic input data, timing data, performance data, training logic input data, training timing data, training performance data, supplemental logic input data, supplemental timing data, supplemental performance data, logic input data classes, training logic input classes or vector representations of logic input data. Machine learning subsystem 116 may also send data to other subsystems, such as predictions of completion dates based on a completion timeline, communication data, lists of estimated completion dates and corresponding completion probabilities, logic input class data and/or a plurality of predicted completion dates for functions to be completed sequentially.

Machine learning subsystem 116 may, for example, utilize supervised or unsupervised learning, linear regression, logistic regression, decision trees, Bayesian algorithms, random forest algorithms, artificial neural networks, support vector machine algorithms or dimensionality reduction algorithms. Machine learning subsystem 116 may be trained through, for example, backpropagation of errors through hidden layers in an artificial neural network. For the purpose of training, machine learning subsystem 116 may receive a plurality of features, including training logic input data, training logic input class data, training timing data or training performance data. Machine learning subsystem 116 may receive a plurality of entries, which may include completion timelines, probabilities of completion before a list of completion dates, or estimated completion dates, in order to train a given model.

Natural language processing subsystem 118 may execute tasks related to analyzing natural language, such as communications from email messages, text messages or audio transcripts, as well as generating such communications. Natural language processing subsystem 118 may include software components, hardware components or a combination of both. Natural language processing subsystem 118 may perform functions such as named entity recognition, machine translation, automatic summarization, text classification or sentiment analysis. Natural language processing subsystem 118 may perform computational operations including cosine similarity calculation, bag-of-words vectorization, term frequency and inverse document frequency (TD-IDF) calculation, text normalization, stemming and lemmatization or word embedding. For example, in some embodiments, natural language processing subsystem 118 may receive logic input data in the form of communications, such as email messages, and may determine a logic input class using automatic summarization, text classification and/or sentimental analysis. In some embodiments, natural language processing subsystem 118 may receive logic input data, which may be in the form of communication data. Logic input data may also be in the form of a vector representation of logic input data. Natural language processing subsystem 118 may perform vectorization of input data as well. Natural language processing subsystem 118 may, in some embodiments, generate communications through a machine learning model (i.e., natural language generation), for example, through machine learning subsystem 116. Data from natural language processing subsystem 118 may be accessible to communication subsystem 112, classification subsystem 114 or machine learning subsystem 116.

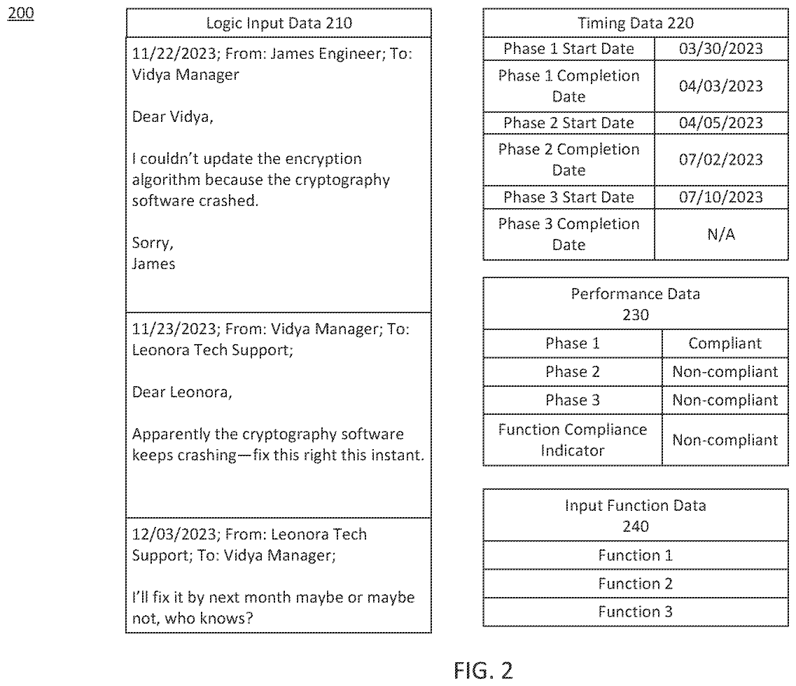

FIG. 2 shows an excerpt of a data structure 200 for a validation request and input function data, in accordance with one or more embodiments. Data structure 200 may include fields 210, 220, 230 or 240. Data structure 200 may store or represent a validation request (e.g., fields 210-230) or input function data 240, which may be stored on a database in data node 104 and communicated to function analysis system 102 through network 150. Data represented in data structure 200 may also originate directly in compliance handling system 108.

Function analysis system 102, through communication subsystem 112, may receive a validation request through network 150 for validating completion of a first function. The validation request may include logic input data 210, timing data 220 and performance data 230. The validation request may contain information relating to whether a function has achieved compliance, as this information is relevant to the prediction of completion timelines. By receiving a validation request, function analysis system 102 may further analyze any reasons for a lack of compliance (i.e., through logic input data 210), and may possess information relating to whether a given process has been delayed or not, and by how long (i.e., through timing data 220). The validation request may also provide information regarding the state of compliance of the process (e.g., performance data), such that function analysis system 102 may predict when compliance may be achieved. Receiving these three types of information confers the benefit of providing enough background information, as well as specific information, to make decisions and predictions regarding the future trajectory of a given process or function.

As referred to herein, a function may include a process, undertaking, initiative, or project that may have requirements for compliance with standards, features, or goals. For example, a function may refer to a software project relating to the development of a particular feature in a software application. A function may exhibit a timeline, deadlines or other measures of time, such as start dates, end dates or compliance achievement dates. Functions may also include multiple phases, where each phase may in turn include start dates, completion dates, or compliance achievement dates, and each phase may refer to a task or sub-task to be completed. The function may need to comply in order to achieve compliance, where compliance may include adhering to regulations, requirements or standards. For example, a software application may require a certain standard of security features, such as encryption of messaging, in order to be considered compliant. As functions can be complicated, long and of large-scale, it is difficult to predict when a function may achieve compliance with the stated goals or requirements. By including contextual information related to the function, function analysis system 102 may better predict the outcomes of compliance initiatives, and may suggest actions to achieve such compliance.

As referred to herein, a validation request may include any data, or messages that contain contextual information regarding a process or function. In some embodiments, a validation request may include logic input data 210, timing data 220, performance data 230, or may include input function data 240. The validation request may originate from a user device, a client device, or a server connected to network 150, and may include a request for specific information to be calculated. For example, a validation request may include a request for suggested communications such that a function may reach compliance, with logic input data 210 in the form of email communications, timing data 220 and performance data 230 attached to the request, and where logic input data 210 may include communication data related to the function. A validation request may be in the form of multiple data structures, or may include one data structure characterized by any and all relevant data.

As referred to herein, logic input data 210 may include any information, data or communications that contain information relating to reasons for compliance or non-compliance of a function. In some embodiments, logic input data 210 may include email messages as shown in FIG. 2, where each email message may contain a date, a subject, a “from” field, a “to” field and a message body. Logic input data 210 may include other communication data, wherein communication data may include any data or information transmitted between different parties. For example, logic input data 210 may include audio transcripts, audio recordings, text messages, physical letters or publications or instant messages. By including logic input data in a validation request, function analysis system 102 may be given enough information to determine any root causes of delays in a function reaching compliance and, as a result, may make an evidence-based prediction of completion timelines based on past processes with similar reasons for failure.

As referred to herein, timing data 220 may include information, data or communications that contain information relating to timelines or time periods of the function or process in question. As shown in FIG. 2, timing data 220 may include information regarding the start and end dates of various phases in the given function, which may be represented in the form of a table or similar data structure, or may be in the form of vectors of timestamps, for example. Timing data 220 may include start and end date information of the function as a whole as well, and/or may include information regarding deadlines or objective dates relating to the function. For example, timing data may include a date where a stakeholder began a given software development project, as well as when a particular phase of the project may have begun or ended. Timing data may also include when compliance with a requirement was achieved, such as when a messaging system in a security-related application was made to include a functioning encryption system. In some embodiments, timing data 220 may be extracted from communication data, such as data contained in logic input data 210. By receiving timing data 220 at function analysis system 102, any calculations or analysis may incorporate temporal contextual information, which may aid in both predicting completion of the function (i.e., achievement of compliance), as well as, upon completion of the function, to serve as training data for machine learning models in subsequent functions or processes.

As referred to herein, performance data 230 may refer to any indications of compliance or performance of the function with respect to a set of requirements or benchmarks. For example, performance data 230 may include a completion status indicator, which may be an indication as to the completion of the function. As shown in FIG. 2, performance data may include whether the function itself, or various phases or tasks within the function, has achieved compliance or not. In some embodiments, compliance may denote completion of the function, phase or task. In some embodiments, functions, phases or tasks may be complete, and yet non-compliant. For example, for an application that incorporates encryption, but where the encryption is to an insufficient standard, the application may be marked as complete but non-compliant. In this case, function analysis system 102 may predict when compliance may be achieved based on data in the validation request received at the system. By including performance data, function analysis system 102 may determine whether, if at all, a function is yet to reach compliance. With greater granularity of performance data relating to phases within the function, function analysis system 102 may, in some embodiments, provide even more specific guidance and predictions relating to the achievement of compliance in each phase of the function. Thus, performance data serves to highlight deficiencies in compliance to function analysis system 102 and to any machine learning model in machine learning subsystem 116, for example.

In some embodiments, function analysis system 102, through communication subsystem 112, may receive supplemental data and, based on this data, determine that the function has been completed and execute a training routine of the machine learning model based on this data. That is, function analysis system 102 may receive, for the first function, supplemental logic input data, supplemental timing data, and supplemental performance data, wherein the supplemental timing data includes a start date and an end date for the first function, and the supplemental performance data includes a completion status indicator for the first function. In response to determining, based on the supplemental performance data, that the first function is complete, the system may execute a training routine of the machine learning model with the logic input data, the timing data, the performance data, the supplemental logic input data, the supplemental timing data, and the supplemental performance data, wherein the training routine updated the machine learning model. For example, communication subsystem 112 may receive additional data relating to the function that supplements the original logic input data, timing data and performance data, in the form of supplemental data.

Supplemental logic input data, timing data and performance data may have similar forms to their respective non-supplemental equivalents 210-240, but may include information added at a later time. For example, a function that has been completed after initial receipt of the validation request may possess supplemental information that includes timeline data regarding completion of the function, as well as performance data that indicates that the function has been completed. Function analysis system 102 may utilize this information to modify and update original logic input data 210, timing data 220 and performance data 230 to reflect the change in information. For example, a software development application that has achieved a satisfactory level of encryption may be deemed “compliant” after an initial verification request was already submitted to function analysis system 102. Subsequently, machine learning subsystem 116 may receive this completion information and utilize this data to train a machine learning model to generate predictions of completion timelines. Thus, function analysis system 102 may enable dynamic training and improvement of function completion timeline prediction upon receipt of new, supplemental information.

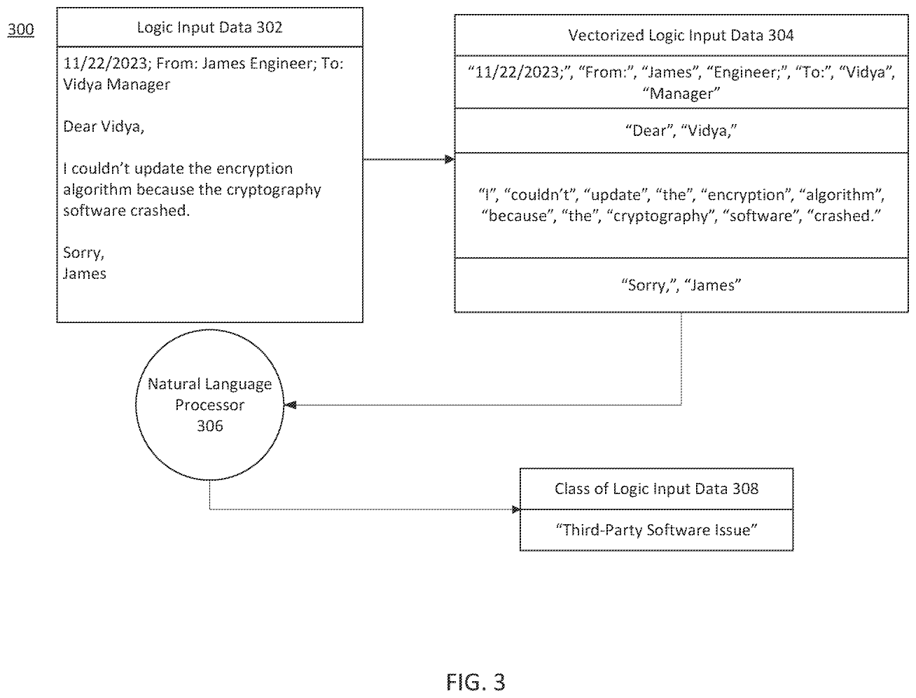

FIG. 3 shows a process 300 for generating a vector representation of logic input data and generating a logic input data class from a natural language processor, in accordance with one or more embodiments. Classification subsystem 114 may, based on the logic input data, determine a class of the logic input data, and add the class to the validation request. For example, function analysis system 102 may generate a vector representation of the logic input data, and may input the vector representation into a natural language processor to generate a class. That is, the system may generate a vector representation of the logic input data and input the vector representation into a natural language processing machine learning model. The natural language processing machine learning model may have been trained using a plurality of vectors of sets of training logic input data. Function analysis system 102 may receive from the natural language processing machine learning model the class of the logic input data. For example, function analysis system 102 may receive, through communication subsystem 112, logic input data 302 (e.g., an email message or other type of communication). Classification subsystem 114 may use other techniques to determine a class of logic input data. For example, a machine learning model, such as artificial neural networks, may be used to compare the logic input data to other similar datasets to determine a corresponding class. By adding the resulting class to the validation request, function analysis system 102 may ensure that any information regarding reasons for non-compliance are considered in any further analysis by machine learning subsystem 116.

Classification subsystem 114 may perform a vectorizing operation to produce vector representation of logic input data 304. For example, classification subsystem 114 may separate an email into lines of text, each of which is a vector. Each line of text may be broken down into vectors of specific words, wherein each word may be a string of alphanumeric characters. Thus, in some embodiments, classification subsystem 114 may produce a vector of vectors of strings of characters. Classification subsystem 114 may send resulting vector representation 304 to natural language processor 306, which may reside in natural language processing subsystem 118. The natural language processor may then generate class of logic input data 308 based on the vectorized logic input data. For example, natural language processor 306 may interpret the email contained in logic input data 302 to explain a lack of non-compliance as being due to a “third-party software issue,” and may generate class 308 accordingly. Classification subsystem 114 may generate a class by using text summarization, for example, or named entity recognition, which may enable problems and issues, such as specific software packages that are inoperative, to be identified.

As referred to herein, a vector representation may include a representation of data (e.g., a transformation of communication data or logic input data 302) that may be in a format processable by natural language processing models or machine learning models. For example, data may be converted into a vector of vectors of alphanumeric strings, as shown in vectorized logic input data 304. In some embodiments, words within vectorized logic input data 304 may further be assigned integers, binary numbers or other representations. For example, natural language processing subsystem 118 may utilize a bag-of-words algorithm, in which input text is tokenized as a list of its constituent words, as is shown in vectorized logic input data 304. Subsequently, unique words within the tokenized text may be selected to create a vocabulary, and a matrix created to represent the frequency of words. Other algorithms, such as TF-IDF, may also be used. Natural language processing subsystem 118 may also utilize machine learning, such as through an interface with machine learning subsystem 116, in order to determine a class based on the vectorized representation of the logic input data.

As referred to herein, a class of logic input data may include a label, summary or characterization of logic input data. For example, the class of logic input data, as shown in FIG. 3, may represent an analysis of logic input data 302 that depicts that a reason for non-compliance of a function is due to a “third-party software issue,” represented by corresponding class 308. The class may involve categorization of the logic input data based on natural language processing, for example. By processing logic input data through natural language processing subsystem 118, function analysis system 102 may deduce any reasons for non-compliance, which may add contextual information that aids in prediction of completion timelines, for example.

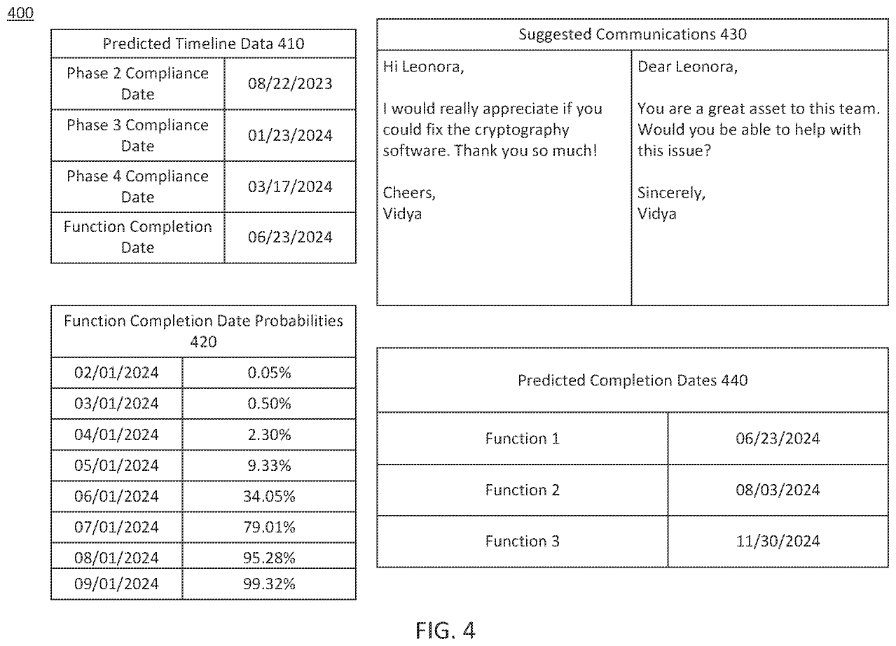

FIG. 4 shows an excerpt of a data structure 400 for predictions from a machine learning model for generating predictions of completion timelines for functions, in accordance with one or more embodiments. Function analysis system 102 may input the validation request into a machine learning model in machine learning subsystem 116 for generating a prediction timeline for the function, and may generate a prediction of a completion date based on completion timeline 410. That is, function analysis system 102 may input the validation request into a machine learning model for generating a prediction of a completion timeline for the first function wherein the machine learning model has been trained using a training dataset comprising a plurality of features and a plurality of entries, and wherein the plurality of features includes training logic input data, training timing data, and training performance data. Machine learning subsystem 116 may, thus, generate the prediction of a completion date based on the completion timeline. For example, machine learning subsystem 116 may receive logic input data 210, timing data 220, performance data 230, and logic input data class 308, and generate predicted timeline data 410. Predicted timeline data 410, for example, may include estimated compliance dates for the function as a whole, or may include estimated compliance dates for each phase or task within the function. For example, machine learning subsystem 116 may predict that a software application may achieve compliance with required encryption standards by a certain date, and output a timeline and predicted completion date that reflects this. By predicting completion dates for the function based on contextual information, such as logic, performance or prior timing information, function analysis system 102 provides the benefit of improving predictions of large-scale initiatives or processes that are non-compliant with standards or requirements.

In some embodiments, machine learning subsystem 116 may generate a list of estimated completion dates and corresponding completion probabilities 420, and determine an estimated completion date from this. That is, function analysis system 102 may receive, from the machine learning model, a list of estimated completion dates and corresponding completion probabilities 420 and determine, based on the list of estimated completion dates and the corresponding completion probabilities, an estimated completion date as the prediction of the completion date. For example, completion probabilities 420 may indicate that there is a more than 50% probability (i.e., a 79.01% probability) of completion before 07/01/2024 and, in response, may determine that the most likely function completion date is 07/01/2024. Machine learning subsystem 116 may determine the list of completion probabilities based on likelihoods that similar functions within training data were completed within similar timelines, for example. The list of estimated completion dates may be automatically selected by function analysis system 102 to sample a suitable or uniform range of time, or these completion dates may be included within the validation request as a query. By providing information about probabilities of completing the function or achieving compliance over many possible dates, function analysis system 102 may provide information regarding the certainty or uncertainty of predicted completion dates, and may give an indication of how accurate the predicted completion date may be. In some embodiments, function analysis system 102 may, using this probability distribution, calculate a standard deviation or another metric for uncertainty in predictions of completion dates, for example.

In some embodiments, function analysis system 102 may calculate probabilities of completion before query completion times using training data from the training dataset. That is, function analysis system 102 may receive a request for a probability of completion before a query completion time, for example, from a network device through communication subsystem 112. Function analysis system 102 may determine, based on the class of the logic input data and the training dataset, a subset of training data matching the class of the logic input data, wherein the subset of training data includes start dates and completion dates. System 102 may determine, based on the start and completion dates, a plurality of elapsed completion times and calculate a percentage of elapsed completion times less than the query completion time. As a result, system 102 may determine the probability of completion before the query completion time. For example, function analysis system 102 may determine other functions that have been classified with the same logic input data class as the current function. In effect, this process enables function analysis system 102 to isolate only those functions with similar reasons for non-compliance. Function analysis system 102 may then determine what percentage of these functions with similar reasons were, in the end, completed/achieved compliance sooner than the query completion time included in the request. By doing so, function analysis system 102 may generate a probability for when the given function may achieve compliance. For example, if 60% of functions that suffered from a “third-party software issue” were able to be completed within 10 weeks, function analysis system 102 may suggest a low likelihood of achieving compliance within 2 weeks of the start date of the function. Thus, function analysis system 102 enables predictions of likelihoods of completion dates based on past data corresponding to similar functions, providing information about the likelihood of compliance before a query date. By doing so, stakeholders may have a more accurate estimate of when compliance may be achieved, and may be able to plan large-scale initiatives accordingly.

In some embodiments, function analysis system 102 may receive input function data 240, generate a validation request with this data and input the request into the machine learning model, and generate multiple predicted completion dates for each function, as shown through predicted completion dates 440 in FIG. 4. That is, communication subsystem 112 may receive input function data, wherein the input function data includes a list of functions to be completed sequentially, and corresponding logic input data, corresponding logic input class data, corresponding timing data and corresponding performance data for each function to be completed sequentially. Function analysis system 102 may generate a second validation request including the input function data and input the second validation request into the machine learning model. Machine learning subsystem 116 may generate, using the machine learning model, a plurality of predicted completion dates for each function in the list of functions to be completed sequentially. For example, communication subsystem 112 may receive logic input data 210, timing data 220 and performance data 230 for each of a list of functions that must be completed sequentially, as shown in input function data 240. Machine learning subsystem 116 may, subsequently, calculate a list of predicted completion dates 440 for each of these functions to be completed sequentially. By doing so, function analysis system 102 may handle large-scale processes or initiatives that may require multiple stages to reach compliance. For example, a security application that requires use of an encryption application may require a distinct encryption application to achieve compliance before even beginning work on the security application. In these cases, function analysis subsystem 102 may generate predictions for these processes or functions in a way that preserves their sequence and requires one function to achieve compliance before another. Thus, functions that depend on compliance of other functions may be considered as well.

As referred to herein, input function data 240 may include information related to multiple functions, where this information may include any contextual information corresponding to each of these functions. For example, input function data 240 may include a list of functions to be completed sequentially, and corresponding logic input data, corresponding logic input class data, corresponding timing data and corresponding performance data for each function to be completed sequentially. In some embodiments, input function data 240 may include information related to interdependencies between the different functions, in a way that does not require strict sequential processing of each function. By receiving input function data 240, function analysis system 102 may handle more complicated functions that depend on one another, and may provide predictions where multiple functions may depend on each other.

As referred to herein, a completion timeline may refer to a list of times relating to a function's completion or compliance. For example, predicted timeline data 410 may be an example of a completion timeline. A completion timeline may include multiple predictions of completion dates, for example. As referred to herein, a prediction of a completion date may refer to a date or time that is calculated and considered to be a likely time at which a function may be completed or may reach compliance. For example, a function that function analysis system 102 has determined to require a dependency that is predicted to take 6 months to install may have a prediction of a completion date of 6 months from the function's start date. In some embodiments, the prediction of a completion date may, in particular, refer to a date at which compliance with requirements, standards or other criteria is satisfied. For example, predicted timeline data 410 may include various predictions of completion dates for multiple phases of the function, or may include a prediction of a completion date for the function as a whole. An estimated completion date may refer to an example of a prediction of a completion date for a particular function, phase or case.

Machine learning subsystem 116 may, additionally, require a training routine. For example, machine learning subsystem 116 may receive a training dataset, determine a class for each entry in the training dataset, add the corresponding class to the entries, and train the machine learning model using the entries. That is, machine learning subsystem 116 may receive the training dataset for training the machine learning model to generate predictions of completion timelines, wherein the training dataset includes the plurality of features and the plurality of entries, and wherein the plurality of features includes the training logic input data, the training timing data and the training performance data. Machine learning subsystem 116, along with natural language processing subsystem 118, may determine, for each entry within the training dataset, a corresponding class of a plurality of classes for the training logic input data, wherein the plurality of classes includes an indication of completion failure. Machine learning subsystem 116 may add the corresponding class to each of the plurality of entries and train the machine learning model to generate the predictions of completion timelines using the training dataset. By including prior data relating to functions, along with logic input data, timing data and performance data, machine learning subsystem 116 may have enough contextual information, using regression or artificial neural networks, for example, to make a prediction of how similar functions may achieve compliance, and how quickly they may achieve this. Thus, machine learning subsystem 116 takes advantage of a wealth of training data relating to prior functions to improve the machine learning model used to make predictions.

As referred to herein, a training routine may include any method that provides a machine learning model with data that improves the accuracy, performance and functioning of the machine learning model. The nature of the training routine may depend on the type of corresponding machine learning model. For example, machine learning subsystem 116 may train neural networks using a gradient descent algorithm, the Newton method, a conjugate gradient algorithm, a quasi-Newton method or a Levenberg-Marquardt algorithm. Feedforward neural networks, particularly, may be trained using backpropagation in conjunction with training algorithms listed above. Linear regression models, for example, may be trained through an ordinary least squares calculation, a gradient descent, or regularization. A particular choice of algorithm may depend on the nature of the input data, such as data type or complexity. By training the machine learning model in this manner, the machine learning model may learn from past data relating to a function's completion and compliance and may, as a result, suggest prediction timelines or other information relating to the future performance of a function.

As referred to herein, a training dataset may include any data that may provide information for training the machine learning model. For example, the training dataset may include features and entries. As referred to herein, entries may include each function for which information is available with respect to compliance. For example, an entry may correspond to features related to a given function for which information is known, where features may include logic input data 210, timing data 220, class of logic input data 308, and/or performance data 230. Training data within the training dataset may also include communication data, which may or may not be incorporated within logic input data 210. As referred to herein, features may include any information related to functions, particularly information regarding completion or achievement of compliance. By including this information, the machine learning model may learn from prior functions that have already achieved compliance, for example. Additionally, machine learning subsystem 116 may possess enough of this historical training data to make accurate predictions for future compliance of functions.

In some embodiments, machine learning subsystem 116, during training, may receive communication data within the training dataset, wherein the communication data includes communications and respective dates, and may train the machine learning model based on this data to output suggested communications 430. That is, machine learning subsystem 116 may receive communication data within the training dataset, wherein the communication data includes a plurality of communications and dates of communications and may train the machine learning model based on the communication data to output a communication for indicating to a user to complete a corresponding function. Machine learning subsystem 116, with natural language processing subsystem 118, may analyze the effectiveness of various communications associated with a given function within the training data and may determine, for the present function, whether a more effective communication may be available for reducing the time needed to reach compliance, using the totality of the information in the training dataset. For example, machine learning subsystem 116 may determine that communications included within logic input data 210 are too curt or disrespectful, which may lead to longer compliance times, while suggested communications 430, i.e., being more respectful and kinder, may lead to shorter compliance times.

As referred to herein, communication data may include any information, data or language transmitted between different entities. For example, communication data may be in the form of email communications between various stakeholders, software developers or other entities. Communication data may also include audio transcripts, audio recordings, text messages, physical letters or publications, or instant messages. Communication data may be found within logic input data, or may be stand-alone. By including communication data, machine learning subsystem 116 may consider qualitative and human factors when determining predictions for completion dates. As humans may drive initiatives and projects, function analysis system 102 may analyze human communications and, accordingly, suggest communications that stakeholders or developers may use more effectively to reach compliance.

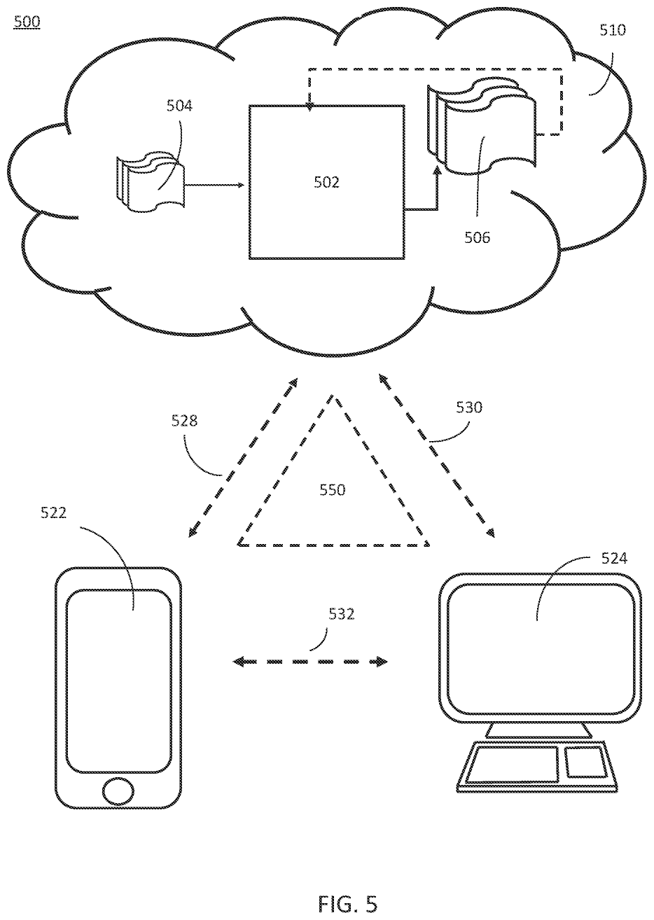

FIG. 5 shows illustrative components for a system used to generate function completion timelines for processes, in accordance with one or more embodiments. For example, FIG. 5 may show illustrative components for determining estimated completion timelines and suggested communications for stakeholders for software development campaigns. As shown in FIG. 5, system 500 may include mobile device 522 and user terminal 524. While shown as a smartphone and personal computer, respectively, in FIG. 5, it should be noted that mobile device 522 and user terminal 524 may be any computing device, including, but not limited to, a laptop computer, a tablet computer, a hand-held computer, and other computer equipment (e.g., a server), including “smart,” wireless, wearable and/or mobile devices. FIG. 5 also includes cloud components 510. Cloud components 510 may alternatively be any computing device as described above, and may include any type of mobile terminal, fixed terminal or other device. For example, cloud components 510 may be implemented as a cloud computing system, and may feature one or more component devices. It should also be noted that system 500 is not limited to three devices. Users may, for instance, utilize one or more devices to interact with one another, one or more servers or other components of system 500. It should be noted that, while one or more operations are described herein as being performed by particular components of system 500, these operations may, in some embodiments, be performed by other components of system 500. As an example, while one or more operations are described herein as being performed by components of mobile device 522, these operations may, in some embodiments, be performed by components of cloud components 510. In some embodiments, the various computers and systems described herein may include one or more computing devices that are programmed to perform the described functions. Additionally, or alternatively, multiple users may interact with system 500 and/or one or more components of system 500. For example, in one embodiment, a first user and a second user may interact with system 500 using two different components.

With respect to the components of mobile device 522, user terminal 524 and cloud components 510, each of these devices may receive content and data via input/output (I/O) paths. Each of these devices may also include processors and/or control circuitry to send and receive commands, requests and other suitable data using the I/O paths. The control circuitry may include any suitable processing, storage and/or I/O circuitry. Each of these devices may also include a user input interface and/or user output interface (e.g., a display) for use in receiving and displaying data. For example, as shown in FIG. 5, both mobile device 522 and user terminal 524 include a display upon which to display data (e.g., conversational response, queries and/or notifications).

Additionally, as mobile device 522 and user terminal 524 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 500 may run an application (or another suitable program). The application may cause the processors and/or control circuitry to perform operations related to generating dynamic conversational replies, queries and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a Universal Serial Bus (USB) port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., (electrically erasable programmable read-only memory) EEPROM, random access memory (RAM), etc.), solid-state storage media (e.g., flash drive, etc.), and/or other electronically readable storage media. The electronic storages may include one or more virtual storage resources (e.g., cloud storage, a virtual private network and/or other virtual storage resources). The electronic storages may store software algorithms, information determined by the processors, information obtained from servers, information obtained from client devices or other information that enables the functionality as described herein.

FIG. 5 also includes communication paths 528, 550 and 532. Communication paths 528, 530 and 532 may include the Internet, a mobile phone network, a mobile voice or data network (e.g., a 5G or LTE network), a cable network, a public switched telephone network or other types of communications networks or combinations of communications networks. Communication paths 528, 530 and 532 may separately or together include one or more communications paths, such as a satellite path, a fiber-optic path, a cable path, a path that supports Internet communications (e.g., IPTV), free-space connections (e.g., for broadcast or other wireless signals) or any other suitable wired or wireless communications path or combination of such paths. The computing devices may include additional communication paths linking a plurality of hardware, software and/or firmware components operating together. For example, the computing devices may be implemented by a cloud of computing platforms operating together as the computing devices.

Cloud components 510 may include function analysis system 102, communication sub system 112, classification sub system 114, machine learning sub system 116, natural language processing subsystem 118, data node 104 or compliance handling system 108, and may be connected to network 150. Cloud components 510 may access compliance handling system 108, as well as related data. For example, cloud components 510 may access logic input data 210, timing data 220, performance data 230, input function data 240, vectorized logic input data 304, class data 308, predicted timeline data 410, function completion date probabilities 420, suggested communications 430 or predicted completion dates 440.

Cloud components 510 may include model 502, which may be a machine learning model, artificial intelligence model, etc. (which may be referred to collectively herein as “models”). Model 502 may take inputs 504 and provide outputs 506. The inputs may include multiple datasets, such as a training dataset and a test dataset. Each of the plurality of datasets (e.g., inputs 504) may include data subsets related to user data, predicted forecasts and/or errors and/or actual forecasts and/or errors. In some embodiments, outputs 506 may be fed back to model 502 as input to train model 502 (e.g., alone or in conjunction with user indications of the accuracy of outputs 506, labels associated with the inputs or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a class for logic input data, estimated or predicted completion dates, predictions of completion timelines, suggested communications and function completion date probabilities).

In a variety of embodiments, model 502 may update its configurations (e.g., weights, biases or other parameters) based on the assessment of its prediction (e.g., outputs 506) and reference feedback information (e.g., user indication of accuracy, reference labels or other information). In a variety of embodiments, where model 502 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 502 may be trained to generate better predictions.

In some embodiments, model 502 may include an artificial neural network. In such embodiments, model 502 may include an input layer and one or more hidden layers. Each neural unit of model 502 may be connected with many other neural units of model 502. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 502 may be self-learning and trained, rather than explicitly programmed, and can perform significantly better in certain areas of problem solving, as compared to traditional computer programs. During training, an output layer of model 502 may correspond to a classification of model 502, and an input known to correspond to that classification may be input into an input layer of model 502 during training. During testing, an input without a known classification may be input into the input layer, and a determined classification may be output.

In some embodiments, model 502 may include multiple layers (e.g., where a signal path traverses from front layers to back layers). In some embodiments, back propagation techniques may be utilized by model 502 where forward stimulation is used to reset weights on the “front” neural units. In some embodiments, stimulation and inhibition for model 502 may be more free-flowing, with connections interacting in a more chaotic and complex fashion. During testing, an output layer of model 502 may indicate whether or not a given input corresponds to a classification of model 502 (e.g., a class of logic input data).

In some embodiments, the model (e.g., model 502) may automatically perform actions based on outputs 506. In some embodiments, the model (e.g., model 502) may not perform any actions. The output of the model (e.g., model 502) may be used to predict or estimate when a function may achieve compliance, or suggested actions or communications that may improve the efficiency of reaching compliance.

System 500 also includes API layer 550. API layer 550 may enable the system to generate summaries across different devices. In some embodiments, API layer 550 may be implemented on user device 522 or user terminal 524. Alternatively, or additionally, API layer 550 may reside on one or more of cloud components 510. API layer 550 (which may be a REST or web services API layer) may provide a decoupled interface to data and/or functionality of one or more applications. API layer 550 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP and JavaScript. SOAP Web services have traditionally been adopted in the enterprise for publishing internal services, as well as for exchanging information with partners in B2B transactions.

API layer 550 may use various architectural arrangements. For example, system 500 may be partially based on API layer 550, such that there is strong adoption of SOAP and RESTful web services, using resources like Service Repository and Developer Portal, but with low governance, standardization and separation of concerns. Alternatively, or additionally, system 500 may be fully based on API layer 550, such that separation of concerns between layers like API layer 550, services and applications are in place.

In some embodiments, the system architecture may use a microservice approach. Such systems may use two types of layers: Front-End Layer and Back-End Layer where microservices reside. In this kind of architecture, the role of the API layer 550 may provide integration between Front-End and Back-End. In such cases, API layer 550 may use RESTful APIs (exposition to front-end or even communication between microservices). API layer 550 may use AMQP (e.g., Kafka, RabbitMQ, etc.). API layer 550 may use incipient usage of new communications protocols, such as gRPC, Thrift, etc.

In some embodiments, the system architecture may use an open API approach. In such cases, API layer 550 may use commercial or open source API platforms and their modules. API layer 550 may use a developer portal. API layer 550 may use strong security constraints applying WAF and DDoS protection, and API layer 550 may use RESTful APIs as standard for external integration.

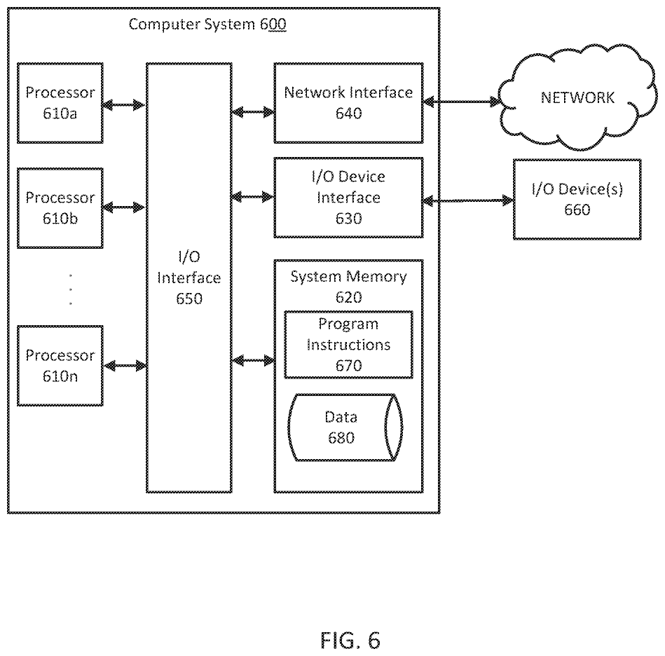

FIG. 6 shows an example computing system that may be used in accordance with some embodiments of this disclosure. In some instances, computing system 600 is referred to as a computer system 600. A person skilled in the art would understand that those terms may be used interchangeably. The components of FIG. 6 may be used to perform some or all operations discussed in relation to FIGS. 1-4, and alongside and/or instead of any components or operations described in FIG. 5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630 and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical and I/O operations of computing system 600. A processor may execute code (e.g., processor firmware, a protocol stack, a database management system, an operating system or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a) or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, for example, an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via a network and network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the Internet, a local area network (LAN), a wide area network (WAN), a cellular communications network or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script or code). A computer program may be written in a programming language, including compiled or interpreted languages, or declarative or procedural languages. A computer program may include a unit suitable for use in a computing environment, including as a stand-alone program, a module, a component or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site, or distributed across multiple remote sites and interconnected by a communication network.

System memory 620 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device or any combination thereof. A non-transitory, computer-readable storage medium may include non-volatile memory (e.g., flash memory, ROM, PROM, EPROM, EEPROM memory), volatile memory (e.g., RAM, static random access memory (SRAM), synchronous dynamic RAM (SDRAM)), bulk storage memory (e.g., CD-ROM and/or DVD-ROM, hard drives) or the like. A non-transitory, computer-readable storage medium may include system storage provided integrally with servers or client devices, or removable storage that is removably connectable to the servers or client devices via, for example, a port or a drive. System memory 620 may include a non-transitory, computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the USB standard.

Embodiments of the techniques described herein may be implemented using a single instance of computer system 600, or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative, and is not intended to limit the scope of the techniques described herein. Computer system 600 may include any combination of devices or software that may perform or otherwise provide for the performance of the techniques described herein. For example, computer system 600 may include or be a combination of a cloud computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

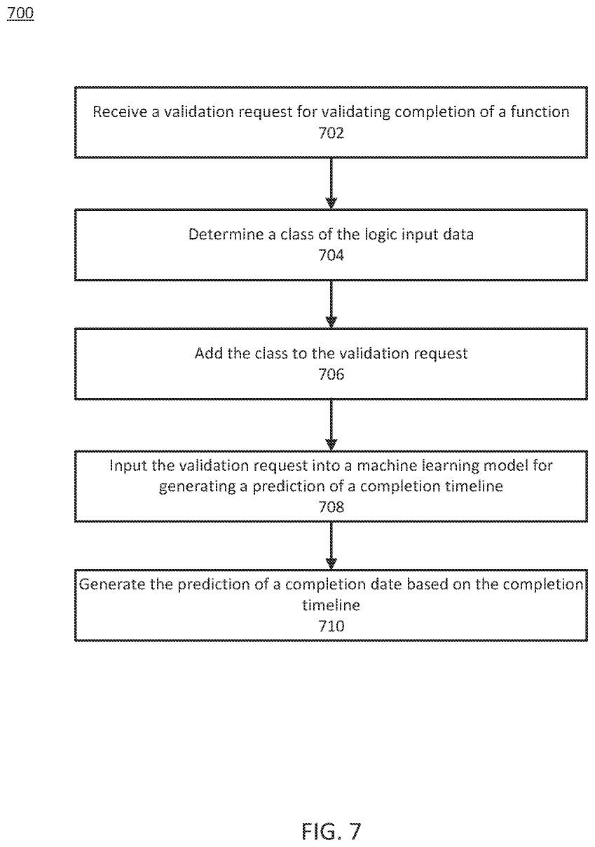

FIG. 7 shows a flowchart of operations for generating function completion timelines using machine learning models, in accordance with one or more embodiments. For example, the system may use process 700 (e.g., as implemented on one or more system components described above) in order to generate function completion timelines for software development campaigns from logic, timing and performance data.

At 702, function analysis system 102 (e.g., using one or more components described above) receives a validation request for validating completion of a function. For example, communication subsystem 112, through network interface 640, may receive a validation request for validating completion of a first function. The validation request may include logic input data 210, timing data 220 and performance data 230, and may be received at cloud components 510, mobile device 522 or user terminal 524 through communication paths 528, 530, 532 or 550. Function analysis system 102 may store the validation request in system memory 620, for example, within data 680. Additionally, the validation request may include programs that may be stored as program instructions 670. The validation request may also be communicated to communication subsystem 112 through, for example, I/O device(s) 660 and I/O device interface 630. Information included in the validation request may include communication data, such as email communications between software developers or text messages, in addition to timeline data that may be stored as vectors or tables in system memory 620. In some embodiments, system 600 may also receive input function data 240 through network interface 640 or I/O device interface 630.

At 704, function analysis system 102 (e.g., using one or more components described above) determines a class of the logic input data 308. For example, function analysis system 102 may access validation request data stored in system memory 620 and process this data through machine learning subsystem 116 and natural language processing subsystem 118, for example, through one or more processors 610a-610n or through I/O interface 650. Processors 610a-610n may, additionally, access training data that may be stored in system memory 620, and may access program instructions 670, for example, instructions relating to machine learning and/or natural language processing algorithms. Training data may be communicated between cloud components 510, mobile device 522 or user terminal 524 through communication paths 528, 530, 532 or 550. Determining a class of logic input data may include a machine learning model, such as model 502 on cloud components 510, where logic input data may serve as inputs 504, and model 502 may output classes of the logic input data as outputs 506. As part of the determination of a class of logic input data, function analysis system 102 may calculate vectorized forms of logic input data and store this information as data 680.

At 706, function analysis system 102 (e.g., using one or more components described above) adds the class to the validation request. For example, processors 610a-610n may determine a class of logic input data and, using I/O interface 650, may store this information in system memory 620 within the same data structure as the validation request, within data 680. By doing so, any further calculations may also access the class of logic input data, along with any other data given in the original validation request.

At 708, function analysis system 102 (e.g., using one or more components described above) inputs the validation request into a machine learning model, for example, in machine learning subsystem 116, for generating a prediction of the completion timeline, for example, as shown as predicted timeline data 410. That is, function analysis system 102 may input the validation request (e.g., as inputs 504) into a machine learning model, such as model 502 in cloud components 510, using processors 610a-610n for generating a prediction of a completion timeline for the first function, which may be included in outputs 506. The machine learning model may have been trained using a training dataset including a plurality of features and a plurality of entries, and wherein the plurality of features includes training logic input data, training timing data, and training performance data. For example, computer system 600 may access the validation request stored in system memory 620 as data 680, and may utilize a machine learning model stored in program instructions 670 in order to calculate predictions of completion timelines using one or more processors 610a-610n, through I/O interface 650. Processors 610a-610n may have access to training data stored in system memory 620, and, in some embodiments, may receive additional supplemental validation request data through network interface 640 or I/O device interface 630 from network 150 or I/O device(s) 660, respectively. Training data, input data and output data may be communicated through communication paths 528, 530, 550 or 532 between cloud components 510, mobile device 522 and/or user terminal 524.

At 710, function analysis system 102 (e.g., using one or more components described above) generates the prediction of a completion date (e.g., predicted timeline data 410) based on the completion timeline. In some embodiments, function analysis system 102 may generate suggested communications 430, function completion date probabilities 420 or predicted completion dates for sequential functions 440. Function analysis system 102 may generate these data through processors 610a-610n, and may, through I/O interface 650, display these results on I/O devices 660. Processing may occur on cloud components 510. Additionally, or alternatively, computer system 600 may send generated results to any device that is connected to network 150, for example, to mobile device 522 and/or user terminal 524, through communication paths 528, 530, 550 or 532. In some cases, these outputs may include warnings or recommendations to take certain actions to reach compliance of a software development process more quickly, for example, in the form of text messages, audio messages or email messages.

It is contemplated that the operations or descriptions of FIG. 7 may be used with any other embodiment of this disclosure. In addition, the operations and descriptions described in relation to FIG. 7 may be done in alternative orders or in parallel to further the purposes of this disclosure. For example, each of these operations may be performed in any order, in parallel, or simultaneously to reduce lag or increase the speed of the system or method. Furthermore, it should be noted that any of the components, devices or equipment discussed in relation to the figures above could be used to perform one or more of the operations in FIG. 7.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques for generating function completion timelines using machine learning models will be better understood with reference to the following enumerated embodiments:

1. A method for generating function completion timelines using machine learning models, the method comprising receiving a validation request for validating completion of a first function, wherein the validation request comprises logic input data, timing data and performance data; determining, based on the logic input data, a class of the logic input data; adding the class to the validation request; inputting the validation request into a machine learning model for generating a prediction of a completion timeline for the first function wherein the machine learning model has been trained using a training dataset comprising a plurality of features and a plurality of entries, and wherein the plurality of features comprises training logic input data, training timing data and training performance data; and generating the prediction of a completion date based on the completion timeline.
2. The method of the preceding embodiment, further comprising receiving the training dataset for training the machine learning model to generate predictions of completion timelines, wherein the training dataset comprises the plurality of features and the plurality of entries, and wherein the plurality of features comprises the training logic input data, the training timing data, and the training performance data; determining, for each entry within the training dataset, a corresponding class of a plurality of classes for the training logic input data, wherein the plurality of classes comprises an indication of completion failure; adding the corresponding class to each of the plurality of entries; and training the machine learning model to generate the predictions of completion timelines using the training dataset.
3. The method of any one of the preceding embodiments, further comprising receiving communication data within the training dataset, wherein the communication data comprises a plurality of communications and dates of communications; and training the machine learning model based on the communication data to output a communication for indicating to a user to complete a corresponding function.
4. The method of any one of the preceding embodiments, further comprising receiving, for the first function, supplemental logic input data, supplemental timing data and supplemental performance data, wherein the supplemental timing data comprises a start date and an end date for the first function, and the supplemental performance data comprises a completion status indicator for the first function; and in response to determining, based on the supplemental performance data, that the first function is complete, executing a training routine of the machine learning model with the logic input data, the timing data, the performance data, the supplemental logic input data, the supplemental timing data and the supplemental performance data, wherein the training routine updated the machine learning model.
5. The method of any one of the preceding embodiments, further comprising: receiving input function data, wherein the input function data comprises a list of functions to be completed sequentially, and corresponding logic input data, corresponding logic input class data, corresponding timing data and corresponding performance data for each function to be completed sequentially; generating a second validation request comprising the input function data; inputting the second validation request into the machine learning model; and generating, using the machine learning model, a plurality of predicted completion dates for each function in the list of functions to be completed sequentially.
6. The method of any one of the preceding embodiments, wherein generating the prediction of the completion date based on the completion timeline comprises receiving, from the machine learning model, a list of estimated completion dates and corresponding completion probabilities; and determining, based on the list of estimated completion dates and the corresponding completion probabilities, an estimated completion date as the prediction of the completion date.
7. The method of any one of the preceding embodiments, wherein determining the class of the logic input data comprises generating a vector representation of the logic input data; inputting the vector representation into a natural language processing machine learning model, wherein the natural language processing machine learning model has been trained using a plurality of vectors of sets of training logic input data; and receiving from the natural language processing machine learning model the class of the logic input data.
8. The method of any one of the preceding embodiments, further comprising receiving a request for a probability of completion before a query completion time; determining, based on the class of the logic input data and the training dataset, a subset of training data matching the class of the logic input data, wherein the subset of training data comprises start dates and completion dates; determining, based on the start dates and the completion dates, a plurality of elapsed completion times; and calculating a percentage of elapsed completion times less than the query completion time and determining the probability of completion before the query completion time.
9. A tangible, non-transitory, machine-readable medium storing instructions that, when executed by a data processing apparatus, cause the data processing apparatus to perform operations comprising those of any embodiments 1-8.
10. A system comprising one or more processors; and memory storing instructions that, when executed by the processors, cause the processors to effectuate operations comprising those of any of embodiments 1-8.
11. A system comprising means for performing any of embodiments 1-8.
12. A system comprising cloud-based circuitry for performing any of embodiments 1-8.

What is claimed is:

1. A system for generating function completion timelines for software development processes using machine learning models, the system comprising:
one or more processors; and
a non-transitory computer-readable storage medium storing instructions, which when executed by the one or more processors cause the one or more processors to:
receive a training dataset for training a machine learning model to predict function completion timelines, wherein the training dataset comprises a plurality of features and a plurality of entries, and wherein the plurality of features comprises training logic input data, training timing data, and training performance data;
determine, for each entry within the training dataset, a corresponding class of a plurality of classes for the training logic input data, wherein the plurality of classes comprises an indication of completion failure;
add the corresponding class to each of the plurality of entries;
train the machine learning model to predict the function completion timelines using the training dataset;
receive a validation request for validating completion of a function, wherein the validation request comprises logic input data, timing data, and performance data;
determine, based on the logic input data, a class of the logic input data;
add the class to the validation request;
input the validation request into the machine learning model for generating a prediction of a completion timeline for the function; and
generate the prediction of a completion date based on the completion timeline.

2. The system of claim 1, wherein the instructions further cause the one or more processors to perform operations comprising:
receiving the training dataset for training the machine learning model to predict the function completion timelines, wherein the training dataset comprises the plurality of features and the plurality of entries, and wherein the plurality of features comprises the training logic input data, the training timing data, and the training performance data;
determining, for each entry within the training dataset, the corresponding class of the plurality of classes for the training logic input data, wherein the plurality of classes comprises the indication of completion failure;
adding the corresponding class to each of the plurality of entries; and
training the machine learning model to predict the function completion timelines using the training dataset.

3. The system of claim 2, wherein the instructions further cause the one or more processors to perform operations comprising:
receiving communication data within the training dataset, wherein the communication data comprises a plurality of communications and dates of communications; and
training the machine learning model based on the communication data to output a communication for indicating to a user to complete a corresponding function.

4. The system of claim 2, wherein the instructions further cause the one or more processors to perform operations comprising:
receiving, for the function, supplemental logic input data, supplemental timing data and supplemental performance data, wherein the supplemental timing data comprises a start date and an end date for the function, and the supplemental performance data comprises a completion status indicator for the function; and
in response to determining, based on the supplemental performance data, that the function is complete, executing a training routine of the machine learning model with the logic input data, the timing data, the performance data, the supplemental logic input data, the supplemental timing data and the supplemental performance data, wherein the training routine updated the machine learning model.

5. A method for generating function completion timelines using machine learning models, the method comprising:
receiving a validation request for validating completion of a first function, wherein the validation request comprises logic input data, timing data, and performance data;
determining, based on the logic input data, a class of the logic input data;
adding the class to the validation request;
inputting the validation request into a machine learning model for generating a prediction of a completion timeline for the first function wherein the machine learning model has been trained using a training dataset comprising a plurality of features and a plurality of entries, and wherein the plurality of features comprises training logic input data, training timing data, and training performance data; and
generating the prediction of a completion date based on the completion timeline.

6. The method of claim 5, further comprising:
receiving the training dataset for training the machine learning model to generate predictions of completion timelines, wherein the training dataset comprises the plurality of features and the plurality of entries, and wherein the plurality of features comprises the training logic input data, the training timing data, and the training performance data;
determining, for each entry within the training dataset, a corresponding class of a plurality of classes for the training logic input data, wherein the plurality of classes comprises an indication of completion failure;
adding the corresponding class to each of the plurality of entries; and
training the machine learning model to generate the predictions of completion timelines using the training dataset.

7. The method of claim 6, further comprising:
receiving communication data within the training dataset, wherein the communication data comprises a plurality of communications and dates of communications; and
training the machine learning model based on the communication data to output a communication for indicating to a user to complete a corresponding function.

8. The method of claim 6, further comprising:
receiving, for the first function, supplemental logic input data, supplemental timing data and supplemental performance data, wherein the supplemental timing data comprises a start date and an end date for the first function, and the supplemental performance data comprises a completion status indicator for the first function; and
in response to determining, based on the supplemental performance data, that the first function is complete, executing a training routine of the machine learning model with the logic input data, the timing data, the performance data, the supplemental logic input data, the supplemental timing data and the supplemental performance data, wherein the training routine updated the machine learning model.

9. The method of claim 5, further comprising:
receiving input function data, wherein the input function data comprises a list of functions to be completed sequentially and corresponding logic input data, corresponding logic input class data, corresponding timing data and corresponding performance data for each function to be completed sequentially;
generating a second validation request comprising the input function data;
inputting the second validation request into the machine learning model; and
generating, using the machine learning model, a plurality of predicted completion dates for each function in the list of functions to be completed sequentially.

10. The method of claim 5, wherein generating the prediction of the completion date based on the completion timeline comprises:
receiving, from the machine learning model, a list of estimated completion dates and corresponding completion probabilities; and
determining, based on the list of estimated completion dates and the corresponding completion probabilities, an estimated completion date as the prediction of the completion date.

11. The method of claim 5, wherein determining the class of the logic input data comprises:
generating a vector representation of the logic input data;
inputting the vector representation into a natural language processing machine learning model, wherein the natural language processing machine learning model has been trained using a plurality of vectors of sets of training logic input data; and
receiving from the natural language processing machine learning model the class of the logic input data.

12. The method of claim 5, further comprising:
receiving a request for a probability of completion before a query completion time;
determining, based on the class of the logic input data and the training dataset, a subset of training data matching the class of the logic input data, wherein the subset of training data comprises start dates and completion dates;
determining, based on the start dates and the completion dates, a plurality of elapsed completion times; and
calculating a percentage of elapsed completion times less than the query completion time and determining the probability of completion before the query completion time.

13. A non-transitory, computer-readable medium storing instructions that, when executed by one or more processors, cause the one or more processors to perform operations comprising:
receiving a validation request for validating completion of a first function, wherein the validation request comprises logic input data, timing data, and performance data;
determining, based on the logic input data, a class of the logic input data;
adding the class to the validation request;
inputting the validation request into a machine learning model for generating a prediction of a completion timeline for the first function wherein the machine learning model has been trained using a training dataset comprising a plurality of features and a plurality of entries, and wherein the plurality of features comprises training logic input data, training timing data, and training performance data; and
generating the prediction of a completion date based on the completion timeline.

14. The non-transitory, computer-readable medium of claim 13, wherein the instructions further cause the one or more processors to perform operations comprising:
receiving the training dataset for training the machine learning model to generate predictions of completion timelines, wherein the training dataset comprises the plurality of features and the plurality of entries, and wherein the plurality of features comprises the training logic input data, the training timing data, and the training performance data;
determining, for each entry within the training dataset, a corresponding class of a plurality of classes for the training logic input data, wherein the plurality of classes comprises an indication of completion failure;
adding the corresponding class to each of the plurality of entries; and
training the machine learning model to generate the predictions of the completion timelines using the training dataset.

15. The non-transitory, computer-readable medium of claim 14, wherein the instructions further cause the one or more processors to perform operations comprising:
receiving communication data within the training dataset, wherein the communication data comprises a plurality of communications and dates of communications; and
training the machine learning model based on the communication data to output a communication for indicating to a user to complete a corresponding function.

16. The non-transitory, computer-readable medium of claim 14, wherein the instructions further cause the one or more processors to perform operations comprising:
receiving, for the first function, supplemental logic input data, supplemental timing data and supplemental performance data, wherein the supplemental timing data comprises a start date and an end date for the first function, and the supplemental performance data comprises a completion status indicator for the first function; and
in response to determining, based on the supplemental performance data, that the first function is complete, executing a training routine of the machine learning model with the logic input data, the timing data, the performance data, the supplemental logic input data, the supplemental timing data and the supplemental performance data, wherein the training routine updated the machine learning model.

17. The non-transitory, computer-readable medium of claim 13, wherein the instructions further cause the one or more processors to perform operations comprising:
receiving input function data, wherein the input function data comprises a list of functions to be completed sequentially and corresponding logic input data, corresponding logic input class data, corresponding timing data and corresponding performance data for each function to be completed sequentially;
generating a second validation request comprising the input function data;
inputting the second validation request into the machine learning model; and
generating, using the machine learning model, a plurality of predicted completion dates for each function in the list of functions to be completed sequentially.

18. The non-transitory, computer-readable medium of claim 13, wherein the instructions for generating the prediction of the completion date based on the completion timeline cause the one or more processors to perform operations comprising:
receiving, from the machine learning model, a list of estimated completion dates and corresponding completion probabilities; and
determining, based on the list of estimated completion dates and the corresponding completion probabilities, an estimated completion date as the prediction of the completion date.

19. The non-transitory, computer-readable medium of claim 13, wherein the instructions for determining the class of the logic input data cause the one or more processors to perform operations comprising:
generating a vector representation of the logic input data;
inputting the vector representation into a natural language processing machine learning model, wherein the natural language processing machine learning model has been trained using a plurality of vectors of sets of training logic input data; and
receiving from the natural language processing machine learning model the class of the logic input data.

20. The non-transitory, computer-readable medium of claim 13, wherein the instructions further cause the one or more processors to perform operations comprising:
receiving a request for a probability of completion before a query completion time;
determining, based on the class of the logic input data and the training dataset, a subset of training data matching the class of the logic input data, wherein the subset of training data comprises start dates and completion dates;
determining, based on the start dates and the completion dates, a plurality of elapsed completion times; and
calculating a percentage of elapsed completion times less than the query completion time and determining the probability of completion before the query completion time.
